(19) United States
(12) Patent Application Publication
(10) Pub. No.: US 2012/0173566 A1
(43) Pub. Date: Jul. 5, 2012

(54) MULTI-FUNCTIONAL NAVIGATION BAR

(75) Inventors: Adam D'Angelo, Palo Alto, CA (US); Charles Duplain Cheever, Palo Alto, CA (US); Kevin G. Der, Palo Alto, CA (US); Rebekah Marie Cox, Mountain View, CA (US)

(73) Assignee: Quora, Inc.

(21) Appl. No.: 12/983,062

(22) Filed: Dec. 31, 2010

(51) Int. Cl. G06F 3/048; G06F 17/30

(52) U.S. Cl. 707/769; 715/780; 707/E17.014

(57) ABSTRACT

A multi-functional navigation bar for a web-based service is described. Consistent with some embodiments of the invention, the navigation bar provides a unified path or user experience for searching for user-generated content that has been posted to a service, and posting new user-generated content to the service. By providing a unified path to perform both the searching and posting functions, the likelihood of the occurrence of redundant or duplicate data is reduced.

### TECHNICAL FIELD

The present disclosure generally relates to data processing techniques. More specifically, the present disclosure relates to methods and systems of preventing occurrences of duplicate data by presenting a multi-functional navigation bar that provides a unified path to search for, and post, an item of user-generated content, such as a question at a question-and-answer service.

### BACKGROUND

Data duplication occurs in a wide variety of contexts and can cause a variety of problems. In general, data duplication occurs when two equivalent, or substantially equivalent, data records are generated to represent the same item of information. For instance, one classic scenario involving issues of data duplication, which is likely to be familiar to many people, is when two identical or nearly identical names, representing the same person, are entered into an electronic address book of a mobile phone or computer. If the data records associated with each duplicate entry in the address book have different contact information (e.g., telephone numbers, email addresses, etc.) for the same person, it becomes burdensome and annoying to quickly locate the desired contact information for the person who has duplicate entries in the address book.

Data duplication issues are likely to arise in the context of a variety of web-based services that rely on user-generated content. For instance, with certain web-based services, multiple users may be independently posting content, and searching for content, such that duplicate content items are ultimately posted to the web-based service. For instance, with a web-based dictionary or encyclopedia service, multiple users may attempt to post entries or articles on the same or similar subjects. In the context of a question-and-answer service, where users are allowed to post questions and answers to questions, data duplication may occur when two users post what is essentially the same question, but phrased with different language. For instance, although phrased differently, the question, “What is the population of San Francisco?” is essentially the same as, “How many people live in San Francisco?” If only one of the questions has been answered, a user's ability to locate the answer will depend on selecting the correct question. Moreover, if two versions of the same question exist, the likelihood that the same answer will be posted twice—one time for each question—increases as well. Over time, as a large volume of questions are posted to the service, the usability of the service may be impacted if there are significant numbers of duplicate questions.

Many data duplication issues are addressed with technical solutions that involve analyzing data sets to identify redundant data, and then deleting or removing one copy of the duplicate data. However, such solutions are corrective, and not preventative, and tend to work best when the data is highly structured, such that the analysis involved in identifying redundant data is straightforward and easy to implement. With extremely large data sets, such as might be involved with a question-and-answer service, identifying redundant data (e.g., questions) from semi-structured data sets is not a trivial task.

### DESCRIPTION OF THE DRAWINGS

Some embodiments of the invention are illustrated by way of example, and not limitation, in the figures of the accompanying drawings, in which:

FIG. 1 is a simple relationship diagram illustrating how some of the various elements and participants of a question-and-answer application are related to one another in a particular embodiment of the invention;

FIG. 2 is a system-level block diagram illustrating some of the system components and functional modules used in implementing a question-and-answer service consistent with an embodiment of the invention;

FIG. 3 is a flow diagram illustrating an example of a method of processing text entered into a multi-functional navigation bar presented as part of the user interface of a question-and-answer service, consistent with some embodiments of the invention;

FIGS. 4, 5 and 6 illustrate an example of a user interface for a question-and-answer service having a multi-functional navigation bar, according to an embodiment of the invention;

FIG. 7 is a flow diagram illustrating an example of a method of processing text entered into a multi-functional navigation bar presented as part of the user interface of a web-based service, consistent with some embodiments of the invention;

FIGS. 8 and 9 illustrate an example of a user interface for a web-based service having a multi-functional navigation bar, consistent with some embodiments of the invention;

FIG. 10 is a block diagram of a machine in the form of a computer within which a set of instructions, for causing the machine to perform any one or more of the methodologies discussed herein, may be stored and executed.

### DETAILED DESCRIPTION

Methods and systems for preventing occurrences of duplicate data by presenting a multi-functional navigation bar that provides a unified path to search for, and post, an item of user-generated content are described. In the following description, for purposes of explanation, numerous specific details are set forth in order to provide a thorough understanding of the various aspects of different embodiments of the present invention. It will be evident, however, to one skilled in the art, that the present invention may be practiced without these specific details.

Consistent with embodiments of the present invention, a multi-functional navigation bar for use with a web-based application or service reduces occurrences of duplicate data, particularly in the context of web-based services that rely on user-generated content, by analyzing text entered at the navigation bar for the purpose of instantly presenting a set of search results from a data source to which the user-entered text is likely to be posted (e.g., added or inserted). By presenting the search results in real time, or near real time, as the user is entering text into the text input box of the navigation bar, the navigation bar enables the user to determine whether the same, or a similar, item of content (represented by the user-entered text) has already been posted, added or inserted, to the particular data source of the web-based service, prior to the user posting the user-entered text to the data source. If, for example, the search results include an item of content that is the same, or similar, to the item of content represented by the user-entered text, the user can avoid posting, adding or inserting a duplicate item of content to the particular data source.

Although the inventive concepts described and illustrated herein are presented in the specific context of a question-and-answer service, skilled artisans will immediately recognize a host of other contexts to which the inventive concepts are applicable. In particular, the inventive concepts described herein will find application in a wide-variety of web-based services that rely on user-generated content, such that users are independently posting, adding or inserting content to one or more data sources accessible via the service. Specific contexts or examples of web-based services to which the inventive concepts are applicable include, but are not limited to, social networking services, dictionary and encyclopedia services, music and video services, search engine services, and many others. Some of the many aspects and advantages of the inventive subject matter are described below in the context of an on-line question-and-answer service.

A question-and-answer application or service provides an on-line forum where users can post questions, post answers to questions, or simply search for and review questions and answers that others have posted. Conventional question-and-answer services typically provide two different paths, or user experiences, for enabling a user to search for a question, and enabling a user to post a question. For instance, with many conventional question-and-answer services, two separate and distinct user interface elements may be utilized to facilitate a search for a question or answer, and to facilitate posting a question to the service. In many instances, the two user interface elements that enable searching for and posting questions are located in separate places on a web page, or even on separate web pages. For example, in many instances, conventional question-and-answer services provide a text input box (sometimes referred to as a search bar) for performing a search, and a separate text input box for posting a question. These two text input boxes may be displayed in two different locations of the same web page, or presented in series, such that the search bar is displayed on a first web page, and the text input box for posting a question is displayed on a subsequently presented web page. For instance, the text input box for posting a question may be displayed on a second web page that includes the search results generated by entering text in the search bar of the first web page. Because conventional question-and-answer services provide two separate and distinct user experiences for searching for questions, and posting questions, users are less likely to search for an existing question before adding a new question. This ultimately leads to the undesirable result of having duplicate questions posted to the question-and-answer service, which often leads to duplicate answers.

Consistent with some embodiments of the invention, a question-and-answer service includes a multi-functional navigation bar that provides a unified path, or user experience, that enables a user to simultaneously search for a question that has been posted to the question-and-answer service and post a question to the question-and-answer service. For instance, consistent with some embodiments, the multi-functional navigation bar provides a single text input box where a user enters text to perform a search, or, to post (e.g., add) a question to the question-and-answer service. As the text of the question is entered into the text input box, the text is processed in real time, or near real time, such that search results are displayed in a drop down list while the user is entering text in the navigation bar. Consequently, if a user's intention is to add or post a new question to the question-and-answer service, as the user enters the text of the question into the text input box, any questions that have similar text satisfying a query based on the text entered by the user will automatically be displayed in a drop down list. If the user finds that the question he or she wants to post to the service has already been posted, then the user can simply select the question from the search results displayed in the drop down list to see any answers that may have been provided to the question. On the other hand, if the search results shown in the drop down list do not include the user's question, the user can simply select a user interface element (e.g., button or link) displayed next to or near the text input box to post the question to the question-and-answer service. Not only does this provide the user with a quick way to find answers to a question, it prevents users from posting questions to the question-and-service when those questions have already been posted, thus limiting the problems that can result from users posting duplicate questions to the question-and-answer service.

With some embodiments, in addition to enabling users to search for and post questions, the navigation bar may enable users to search for other content items associated with the question-and-answer service. For instance, with some embodiments, the navigation bar enables users to enter text for the purpose of searching for other users of the question-and-answer service, topics to which questions and answers are assigned, lists of frequently asked questions concerning a particular topic, and other content items. As such, when a user enters text in the text input box, the text is used as the basis for generating a query that is executed against multiple data sources in real time, or near real time. The results, which are displayed in real time as the user interacts with the text input box, may be ranked and ordered when presented in the search results list based on a variety of factors. For instance, some factors that may be utilized in establishing an order in which search results are displayed include: prior activity of other users, number of people following a topic or question, number of answers provided to a question, number of topics to which a question has been assigned that are also topics being followed by the user performing the search, an existing relationship between a user and the user performing the search, and a variety of others.

With some embodiments, the navigation bar may enable users to search not only for content items associated with a question-and-answer service, but also content items associated with one or more other web-based services. For instance, with some embodiments, the navigation bar may be utilized with any number and different types of web-based services, such as a social network service, a search engine service, a messaging or email service, or some other web-based portal. The navigation bar may be particularly useful with certain web-sites, or web-based portals, that offer multiple web-based services under a single domain or site, such as a social network service that includes multiple services such as a photo sharing service, an on-line gaming service, a messaging service, as well as a question-and-answer service. In such cases, the text entered into the text input box of the navigation bar may be analyzed for the purpose of predicting or determining the particular type of query that the user intends to submit, or the particular type of content that the user is likely to post. Based on an analysis of the entered text, the navigation bar may select one of multiple data sources to search. If, for example, the user-entered text includes one or more commonly used question words, such as “Who”, “When”, “Where”, “How”, or “What”, the navigation bar may present a list of search results containing questions that have previously been posted to a question-and-answer service associated with, or available via the particular social network or web-based portal. If, however, the user-entered text is highly suggestive of a query intended for some other service, the navigation bar will select a data source associated with another service and display search results from the selected data source. For instance, in the context of a social network service, the navigation bar may display a list of friends, business contacts, or other persons determined to be within a social network of a user, when the user enters text in the navigation bar that is determined to be a name. Other aspects of the inventive subject matter will be readily apparent from the description of the figures that follows.

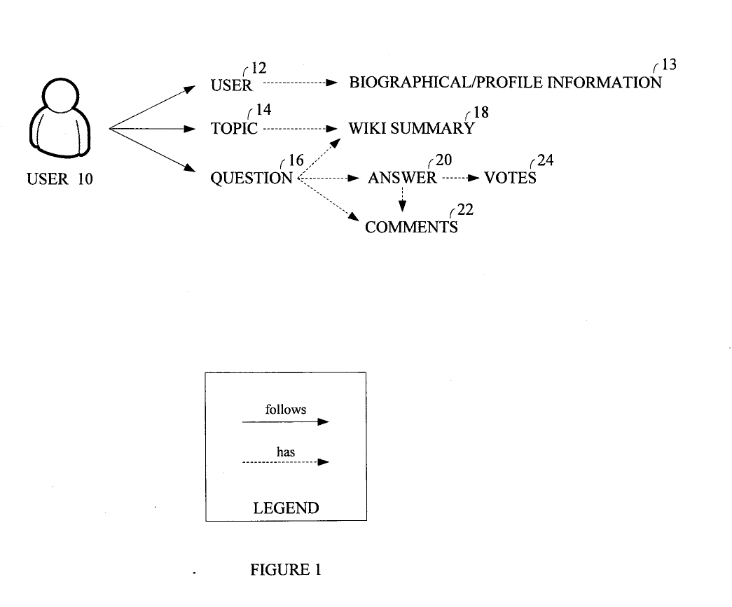

FIG. 1 is a simple relationship diagram illustrating how some of the various elements and participants of a question-and-answer service are related to one another in a particular embodiment of the invention. For instance, as illustrated in FIG. 1, a user 10 of the question-and-answer service may follow another user 12, a topic 14, or a question 16. As used herein, the concept of “following” is somewhat analogous to the concept of subscribing in a subscription-based model. In contrast to the concept of two users being “connected” (e.g., in a social networking context), which typically implies a personal relationship between the users, when a user follows another user, there is no implied personal relationship between the two users. For instance, a first user may follow a second user simply because the first user believes the second user is particularly insightful with respect to a particular topic of interest. By “following” another user, a user can be automatically informed of activities of the other user. If, for example, user A is following user B, when user B posts a question or an answer to a question, user A will be notified of user B's posting activity. Similarly, if a user elects to follow a particular topic, as new questions are assigned to the particular topic, the user can be automatically notified of these new questions. In yet another example, if a user follows a particular question, as new answers are posted to the particular question, the user will be notified of the new answers.

In some embodiments of the invention, notifications may be communicated to a user by simply including the relevant content in a landing page or data feed displayed to the user. For example, when a user first provides his or her authentication information (e.g., username/password), the user may be presented with a personalized home page or landing page with content that is customized for the user. This content may be selected to include information regarding the users, topics and questions that the particular user is following. Additionally, in some embodiments, notifications may be communicated in near real time to a user via any number of conventional and well-known messaging mechanisms, to include email, SMS or text messages, instant messages, and others. In some embodiments, a user may elect to be notified of certain activities or events on a per-question, per-topic or per-user basis. For instance, a user may elect to receive an email notification anytime a new answer is posted to a particular question that the user has posted, and is thus following by default.

Referring again to FIG. 1, a topic 14 may have a wiki summary 18 that provides a summary or some additional description of what subject matter is encompassed by the particular topic. Similarly, a question 16 may have a wiki summary 18 that provides some description or additional context for the question. In some embodiments, the wiki summary 18 for topics and questions may be user-editable by all users, while in other embodiments, only certain users will have the authority to edit a wiki summary. For instance, in some embodiments, only the person who posted a particular question may be authorized to edit the wiki summary for that particular question. In some embodiments, users may be assigned roles that determine various content or access privileges the users have with respect to different topics or questions. For instance, certain users may be assigned an “editor” role for a particular topic, thereby providing those users with editing privileges that are different from those of a regular user.

In addition to a wiki summary 18, a question 16 is associated with one or more answers 20. For instance, after a user posts a question, other users of the application are able to provide answers to the question. In some embodiments of the invention, any user is allowed to post an answer to a particular question. As such, a question may be associated with or have multiple answers. In some embodiments, both questions 16 and answers 20 may have comments. For instance, a user may provide a textual comment that is associated with a question 16 or an answer 20. A comment associated with an answer, for example, could provide some clarification about a particular answer, or some aspect of the answer. Other users can then view the comments when viewing the question and/or answers.

In some embodiments of the invention, an answer 20 has or is associated with votes 24. For example, users can vote up or vote down a particular answer based on whether the user finds the answer helpful in view of the particular question. For instance, if a user believes that a particular answer to a question is a good answer, the user can select a button or other graphical user interface element to vote for the answer. Similarly, if a user believes that a particular answer is not helpful in light of the question, the user can vote down the answer, for example, by simply selecting a button or other graphical user interface element to indicate that the answer is not helpful. In some embodiments, the number of votes for and against an answer is used as an input to an algorithm that determines how answers are to be displayed when presented to a user. For example, the votes for and against an answer may simply be tallied, such that a vote for the answer offsets a vote against the answer, and the answers with the highest vote tallies are displayed in the most prominent positions—typically, at the top of a list of relevant answers.

By providing a forum that includes questions, answers, comments and votes, the question-and-answer service encourages meaningful discussion about a whole host of subject matters, in part, by enabling users to interact with the service in a variety of ways. For instance, some user may desire an entirely passive experience, and can therefore simply browse for, and read, questions and answers on topics of interest. Some users may desire an experience including a moderate level of participation, and as such, these users can vote up or down various answers on topics of interest, and possibly provide commentary. Others may desire to participate more actively, and will elect to post questions and answers to questions.

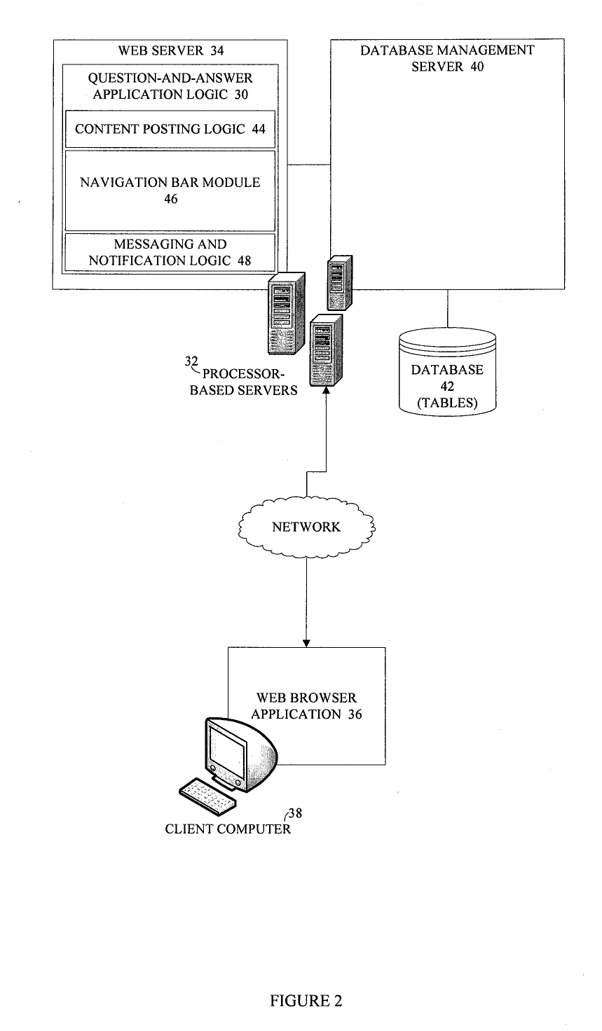

FIG. 2 is a system-level block diagram illustrating some of the system components and functional modules used in implementing a question-and-answer service that includes a multi-functional navigation bar providing a unified path for searching for, and posting, questions at the question-and-answer service, consistent with some embodiments of the invention. As illustrated in FIG. 2, in some embodiments, a question-and-answer service is implemented as a web-based application having application logic 30 residing at one or more processor-based computer servers 32. At least some of the servers 32 include a web server 34 component for serving data (e.g., documents or web pages) to a conventional web browser application 36 residing and executing at a client computer 38. In addition, or as an alternative, the web server 34 may utilize one or more web-based protocols to serve content to non-web browser clients, such as a web-based mobile application residing and executing on a mobile device, a set top box, or some other computing device.

As illustrated in FIG. 2, a client computer 38 executes a web browser application 36 to access the web-based question-and-answer application. In various alternative embodiments, the client computer 38 may be a mobile computing device, to include: a laptop, mobile phone or tablet computer. As such, in some embodiments, the application may have an interface that is customized for display in a browser, or mobile application, of a mobile device. Furthermore, with some embodiments, the client-based application may not be browser-based, but instead may be customized to suit the particular operating system of the device on which it is executing. For instance, a customized application may utilize one or more application programming interfaces that are unique to the particular device and operating system on which the customized application resides and executes.

The question-and-answer application logic 30 is shown in FIG. 2 to include content posting logic 44, a navigation bar module 46, and messaging and notification logic 48. In general, the content posting logic 44 enables users to post questions, answers and comments, as well as other content-related items of information. As described in greater detail below, the navigation bar module 46 operates in conjunction with the content posting logic 44 to receive and process text that is entered into a text input box displayed as part of a web page by the web browser application 36 executing on a client device 38. For example, the navigation bar module 46 receives text, and formulates the text into a query, which is then executed against one or more data sources (e.g., database tables 42) to select content for presentation in a set of search results via the user interface portion of the navigation bar. With some embodiments, the received text may first be analyzed to determine one or more types of content to which the text relates. Based on the determined content type or types, one or more particular data sources will be selected. The query, which is generated based on the user-entered text, is then executed against the one or more data sources that have been selected to obtain a variety of search results. The navigation bar module 46 processes the search results obtained from executing the query or queries, for example, by ranking, ordering and in some instances, intermingling different types of search results, and then communicates the processed search results to the web browser application 36 for display on the web page including the navigation bar. The received text is said to be processed in real-time because it is communicated from the client device 38 to the question-and-answer service while the text is being entered by a user, without the user needing to select a link or button to submit the text to the question-and-answer service. For instance, with some embodiments, a programming technique using a group of interrelated technologies referred to as Ajax (Asynchronous JavaScript and XML) is utilized to allow the asynchronous exchange of data to occur in the background between the application on the client device (e.g., web browser) and the question-and-answer service executing on a server, without interfering with the display and behavior of the currently displayed web page. As such, the search results that are displayed at the client device can be automatically and dynamically updated to reflect the changing text that is being entered by a user in the text input box.

The messaging and notification logic 48 operates in conjunction with the content posting logic 44 to facilitate the generation and communication of messages and notifications. Of course, the application logic 30 may include a number of other logical components to perform a variety of other tasks and functions beyond the immediate scope of the present inventive subject matter. As such, to avoid obscuring the inventive subject matter in unnecessary detail, these various functional components have not been included in FIG. 2.

In some embodiments, some of the various functional components of the question-and-answer application, including some of the various software modules, may be distributed across several server computers, providing application reliability and scalability. For instance, as illustrated in FIG. 2, the database management server 40 is shown to reside on a separate server computer. However, in other embodiments the database management server 40 might reside and execute at the same server as the application logic 30 and web server 34. In any case, the database management server 40 facilitates the writing and reading of data stored in tables of a database 42. In some alternative embodiments, other data structures may be utilized in addition to, or in place of, database tables.

Consistent with some embodiments, the question-and-answer service is a stand-alone service accessible via its own unique address (e.g., URL or URI). With some embodiments, the stand-alone service may leverage its own social layer, or a social layer provided by an externally-hosted social network service. Accordingly, various relationships between users, as determined or defined by the question-and-answer service or an externally-hosted social network service, may be utilized to customize the functionality and features of the question-and-answer service. For example, search results displayed via the navigation bar may be ranked and ordered based, at least in part, on the relationship that the user performing the search has with other users, as that relationship is defined by the question-and-answer service, or an external social network service. Alternatively, with some embodiments, the question-and-answer service may be one of several applications or services that are associated with, and provided by, a social network service. For instance, the question-and-answer service may be accessible via the same address or domain by which users access a social network service, such that the question-and-answer service is hosted by the same entity providing the social network service.

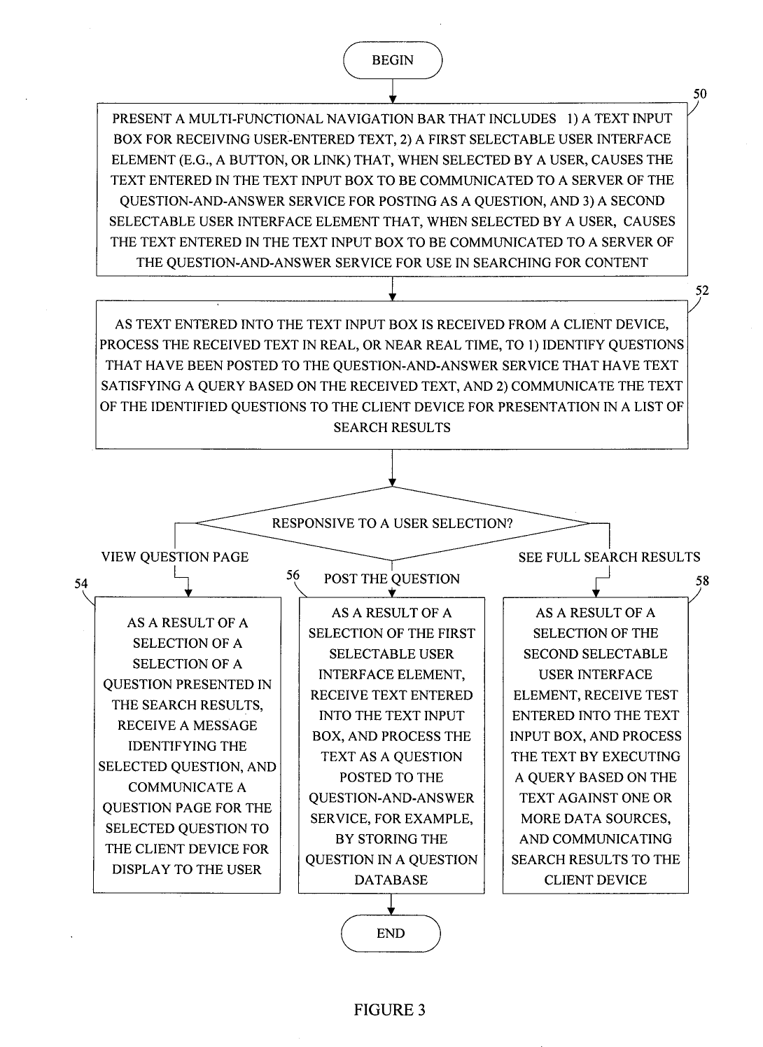

FIG. 3 is a flow diagram illustrating an example of a method of processing text entered into a multi-functional navigation bar presented as part of the user interface of a question-and-answer service, consistent with some embodiments of the invention. As illustrated in FIG. 3, the method begins at method operation 50 when a question-and-answer service presents (e.g., serves to a client device the relevant code or document) a multi-functional navigation bar as part of the user interface of the question-and-answer service. The multi-functional navigation bar includes a text input box where a user of the question-and-answer service can enter text, for example, to search for an existing question, or post a new question. In addition, the multi-functional navigation bar includes a first user-selectable user interface element, such as a button, link, or other graphical element. The first user interface element, when selected by a user, causes any text that has been entered into the text input box to be communicated or submitted (e.g., via an HTTP Post request, or similar operation) to a server of the question-and-answer service for processing as a posted question. In addition to the first user interface element, the multi-functional navigation bar includes a second user interface element, which, when selected by a user, causes any text entered into the text input box to be communicated or submitted (e.g., via an HTTP Post request, or similar operation) to a server of the question-and-answer service for use as the basis of a query to be executed against one or more data sources. For example, selecting this second user interface element causes the service to handle the received text as a keyword or phrase for the purpose of performing a search.

Next, at method operation 52, after the essential elements of the navigation bar have been rendered and displayed at the client device, as text is being entered by a user into the text input box presented as part of the user interface of the question-and-answer service, the text is communicated to and received by a server of the question-and-answer service. The text entered into the text input box is communicated to the server asynchronously, so as not to disturb the display of the currently displayed user interface (e.g., web page). When received at the server, the text is processed to identify questions that have been posted to the question-and-answer service, and that satisfy a query that is based on the received text. For instance, the text received at the server is formulated into a query that is executed against one or more database tables to select one or more questions having text that satisfies the query. The questions identified (e.g., satisfying the query) are then communicated to the client device for presentation in a list of search results. Because the client device and the server exchange data asynchronously in real or near real time, the search results that are displayed at the client device can be automatically and dynamically updated as text is entered, deleted and/or edited in the text input box displayed at the client device. This allows the user to view questions that may match the entered text, and potentially select a question from the search results to view any answers provided to the selected question, if the question is the same, or similar, to the question that the user was considering posting to the question-and-answer service.

After a user has entered some text into the text input box, and the server of the question-and-answer service has received the text, and responded to the client device with the text of one or more questions that satisfy a query based on the received text, the user may make one of three selections. For instance, if the user desires to view a question page for additional information about one of the questions presented in the search results, the user may select the question from the list of the search results. Accordingly, at method operation 54, as a result of the user selecting a question shown in the search results, the question-and-answer service will receive a message identifying the selected question. In response, the question-and-answer service will reply to the client device by communicating the question page for the selected question to the client device for display to the user.

If the user does not see a question in the search results that corresponds with the question that the user is considering posting to the question-and-answer service, the user may select the first user interface element, causing the text entered into the text input box to be submitted to the question-and-answer service as a new question. Accordingly, at method operation 56, as a result of the user selecting the first user interface element, the question-and-answer service receives the text entered into the text input box, and processes the text as a new question posting, for example, by storing the text of the question in a database.

Finally, if the user would like to see a more complete selection of search results, the user may select the second user interface element, which causes the text entered in the text input box to be communicated to the question-and-answer service and used as the basis of a query to search for relevant questions, topics, users, or other content items. Accordingly, at method operation 58, as a result of the user selecting the second user interface element, the question-and-answer service receives the text entered into the text input box, and processes the text by formulating a query to be executed against one or more data sources. The search results generated by processing the query are then communicated to the client device for display in a web page.

With some embodiments, the first and second user interface elements may only be displayed after the user has entered some text into the text input box, and the question-and-answer service has analyzed the text. Accordingly, with some embodiments, the function or operation performed when the first user interface element is selected may be customized based on the analysis of the text entered into the text input box. For example, the question-and-answer service may analyze the text entered into the text input box to determine that the text is representative of a question, and only then present the first user interface element that, when selected, causes the user-entered text to be posted to the question-and-answer service as a question. Similarly, the particular data source that is searched, as a result of a user selecting the second user interface element, may be customized based on an analysis of the text entered in the text input box. For example, if the text entered in the text input box is representative of a question, the second user interface element may, when selected, cause a query to be executed against a data source storing questions. However, if the text entered in the text input box is determined to be representative of a name or a topic, the second user interface element may, when selected, cause the user-entered text to be used in a query that is executed against a data source storing user's names or topics, respectively.

With some embodiments, the navigation bar operates by responding to key presses instead of, or, in addition to, the selection of user interface elements displayed as part of the user interface. For instance, with some embodiments, the text input box may be displayed without any associated user interface elements (e.g., buttons or links). If a user presses a particular key on a keyboard, the navigation bar may communicate the text in the text input box to the question-and-answer service for processing. Similarly, certain key presses may perform different operations or functions with the text entered into the text input box. For example, by pressing a first key, the user-entered text may be posted to the question-and-answer service as a new question. A second key may cause the user-entered text to be communicated to the question-and-answer service for the purpose of performing a search of questions. Other keys may allow a user to search for other users, or topics.

With some embodiments, the text that is entered into the text input box and received at the question-and-answer service may be analyzed to determine what type of search result is to be displayed. For example, if the text includes a common question word, such as “Who”, “When”, “Where”, “How”, “What”, and so forth, the text will be used in a query to search a database of questions, and the most relevant questions will be presented in the search results. Similarly, if the entered text begins with a noun, a query may be executed against a database of topics, and one or more topics may be returned in the search results. Finally, if the received text matches one or more names of users, particularly a user who is being followed by the user performing the search, the names of the users may be returned in the search results. With some embodiments, various factors may be analyzed as part of an algorithm to select what type of content (e.g., questions, topics, users, other) is to be presented in the search results, and in what order the search results are to appear.

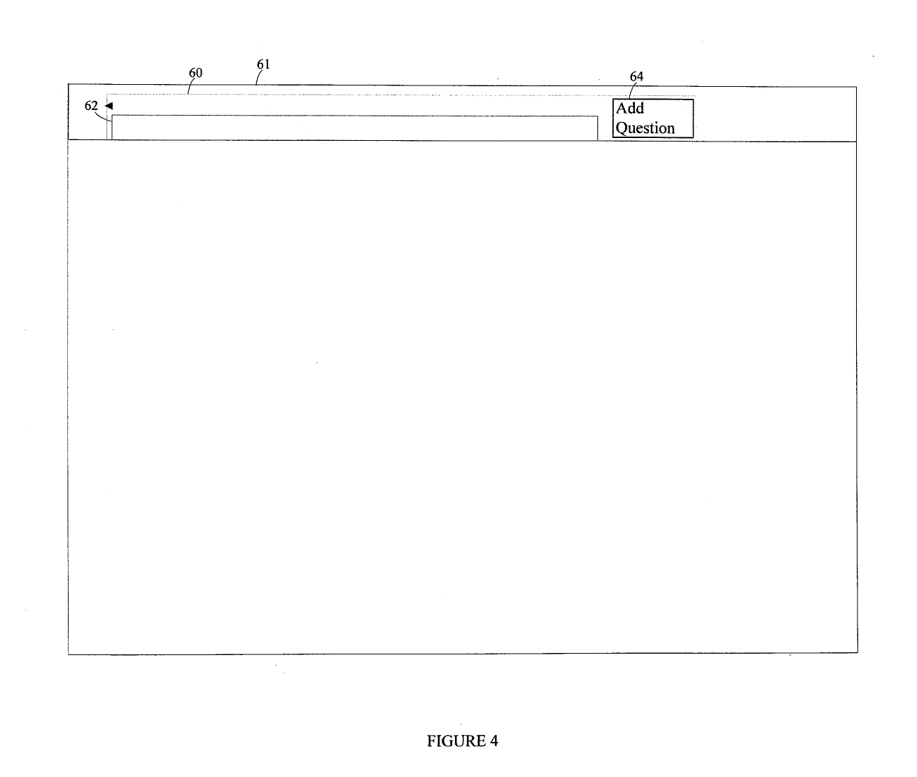

FIGS. 4, 5 and 6 illustrate an example of a user interface for a question-and-answer service having a multi-functional navigation bar, according to an embodiment of the invention. Specifically, FIGS. 4, 5 and 6 illustrate an example of how the user interface changes dynamically as text entered in the text input box is communicated asynchronously from the client device to a server of the question-and-answer service, over a short period of time during which the user is entering the text of a question in the text input box. To avoid obscuring the invention in unnecessary detail, other user interface elements that would likely appear as part of the user interface of the question-and-answer service have been left out of FIGS. 4, 5 and 6. Furthermore, skilled artisans will recognize that the example user interfaces presented herein are displayed for the purpose of conveying an understanding of the inventive subject matter. Accordingly, various alternative user interfaces and user interface elements may be utilized without departing from the overall scope and spirit of the invention.

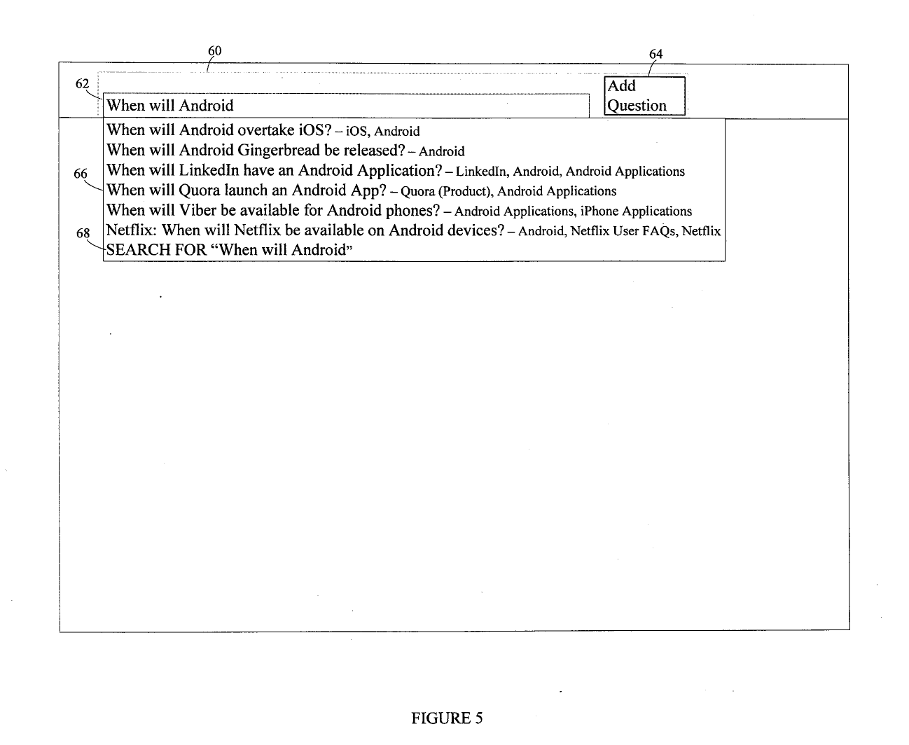

As illustrated in FIG. 4, the navigation bar 60 is located in a page header 61 and includes a single text input box 62 where a user can enter text, and a single user-selectable user interface element in the form of graphical button 64 with the label, “Add Question.” The same header 61 and navigation bar 60 are shown in FIG. 5 after a user has begun entering the text of a question in the text input box 62. More specifically, a user has entered the text, “When will Android,” in the text input box 62 of the navigation bar 60. As the text is entered, it is asynchronously communicated from the client device that is displaying the user interface to a server of the question-and-answer service. When received at the server, the text is processed, for example, by generating and executing a query based on the received text. Then, the text of any questions that satisfy the query are communicated from the server of the question-and-answer service back to the client device, which displays the search results as a drop down list of questions 66. Each individual entry in the list of questions 66 is user-selectable, such that, if selected by the user, a request for the question page for the corresponding question is communicated from the client device to the server of the question-and-answer service. If, for example, after entering just the words, “When will Android”, the user sees a question of interest, the user can simply select the question and the question page for the selected question will be displayed, along with any answers that may have been provided to the selected question.

In the example shown in FIG. 5, the last entry in the drop down list is a user interface element in the form of a link 68, with the text, “SEARCH FOR ‘When will Android’”. By selecting this last item in the list, a user can query the question-and-answer service for a more complete set of search results, using the text that has been entered into the text input box as the basis of a query. For instance, when the search link 68 is selected, the question-and-answer service performs a search with a query based on the text, “When will Android,” and then presents a new web page with a complete list of search results. In some embodiments, the complete list of search results may show not only relevant questions, but one or more topics.

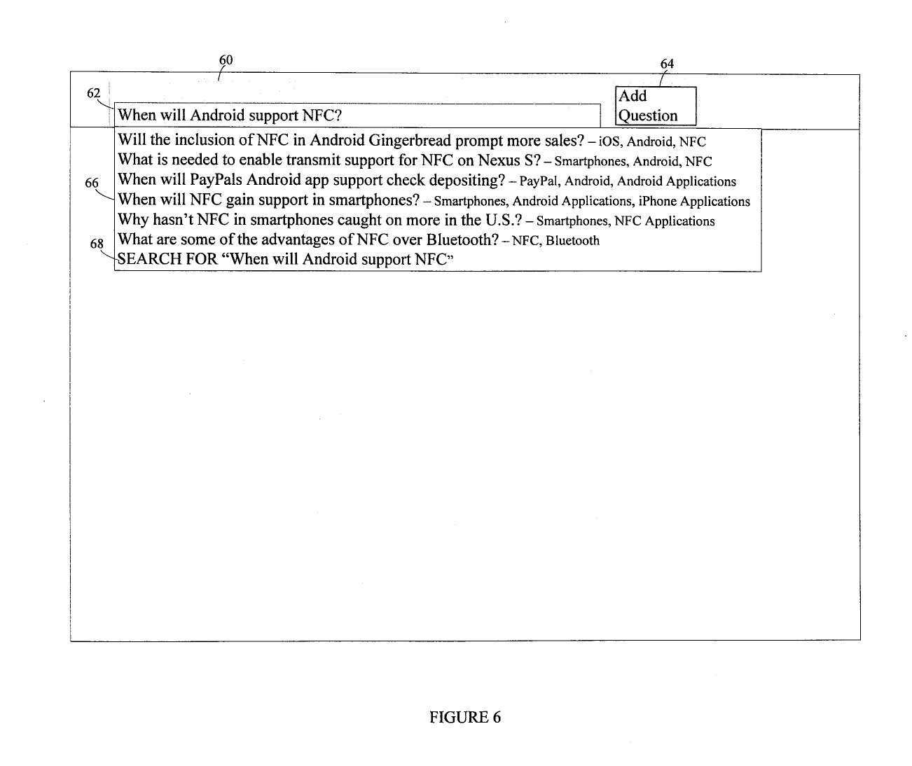

FIG. 6 illustrates the same user interface shown in FIGS. 4 and 5, but after the user has entered the complete text of a question into the text input box 62. As shown in FIG. 6, after entering the complete question in the text input box 62, the search results have been automatically and dynamically updated to reflect the additional text that was entered into the text input box 66. If, after entering the text of a question into the text input box, the user is not satisfied with any of the questions presented in the search results, the user can select the button 64 with label, “Add Question,” to have the text entered into the text input box posted to the question-and-answer service as a new question. With some embodiments, a pop-up window or dialogue box may appear after selecting the “Add Question” button 64, where the pop-up window or box provides tips on how best to phrase a question, and/or prompts the user to confirm that the text entered in the text input box should be posted as a new question.

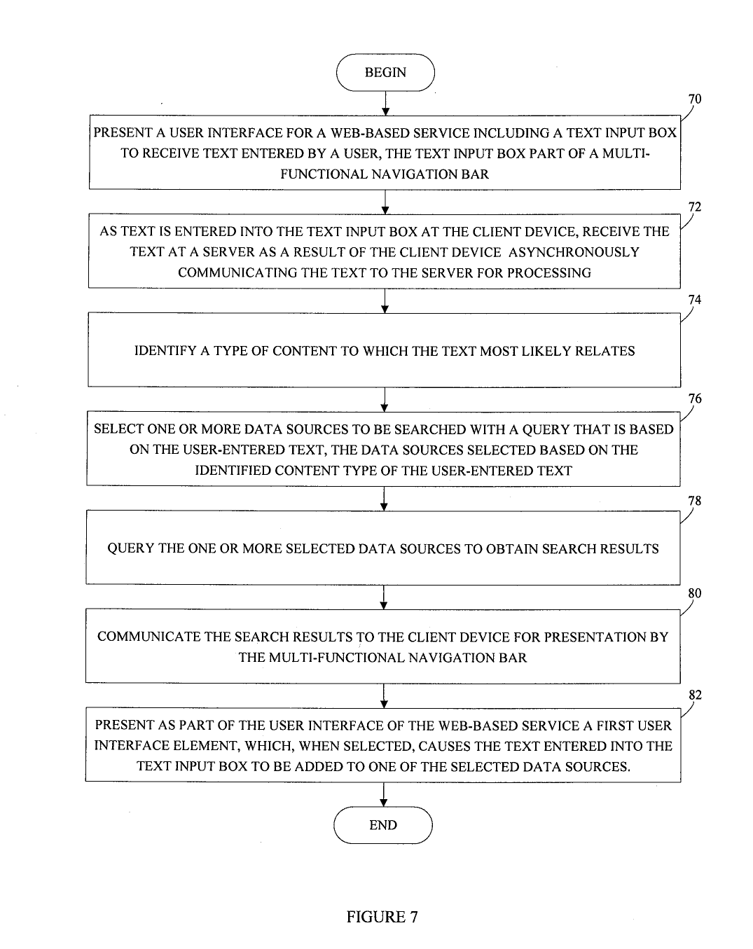

FIG. 7 is a flow diagram illustrating an example of a method of processing text entered into a multi-functional navigation bar presented as part of the user interface of a web-based service, consistent with some embodiments of the invention. As illustrated in FIG. 7, the method begins at method operation 70 when a server associated with the web-based service presents (e.g., serves to the client device) a user interface including a text input box that is part of a multi-functional navigation bar. At method operation 72, as a user enters text into the text input box displayed at the client device, the client device asynchronously communicates (e.g., using AJAX, or similar technologies) the entered text to the server for processing. At method operation 74, the server associated with the web-based service receives the text, and analyzes the text to identify a type of content to which the text most likely relates. For example, in the context of a question-and-answer service, the text may be analyzed to determine whether it is representative of a question, a user name, a topic, or some other content item. Next, at method operation 76, the server selects one or more data sources to be searched with a query based on the user-entered text. The data sources are selected based on the content types identified in method operation 74. At method operation 78, the server queries one or more selected data sources with a query based on the user-entered text to obtain search results. The search results may be ranked and ordered, before the server communicates the search results to the client device for presentation at method operation 80. For example, with some embodiments, the search results may be displayed or presented in a drop down list that is part of the navigation bar. Finally, at method operation 82, the server presents as part of the user interface of the web-based service a user interface element, which, when selected by a user, causes the text entered into the text input box to be communicated to the server for posting (or, adding) to a particular data source. As such, if after entering text in the text input box a user does not see a search result that satisfies the user, the user can select the user interface element to post or add the text entered into the text input box to an appropriate data source at the server executing the web service.

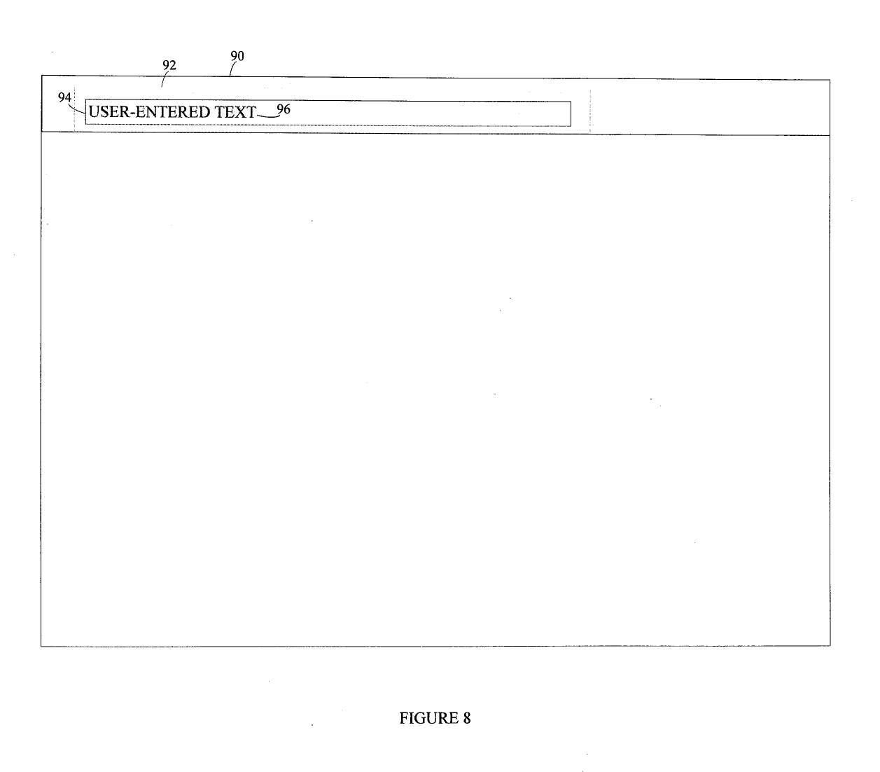

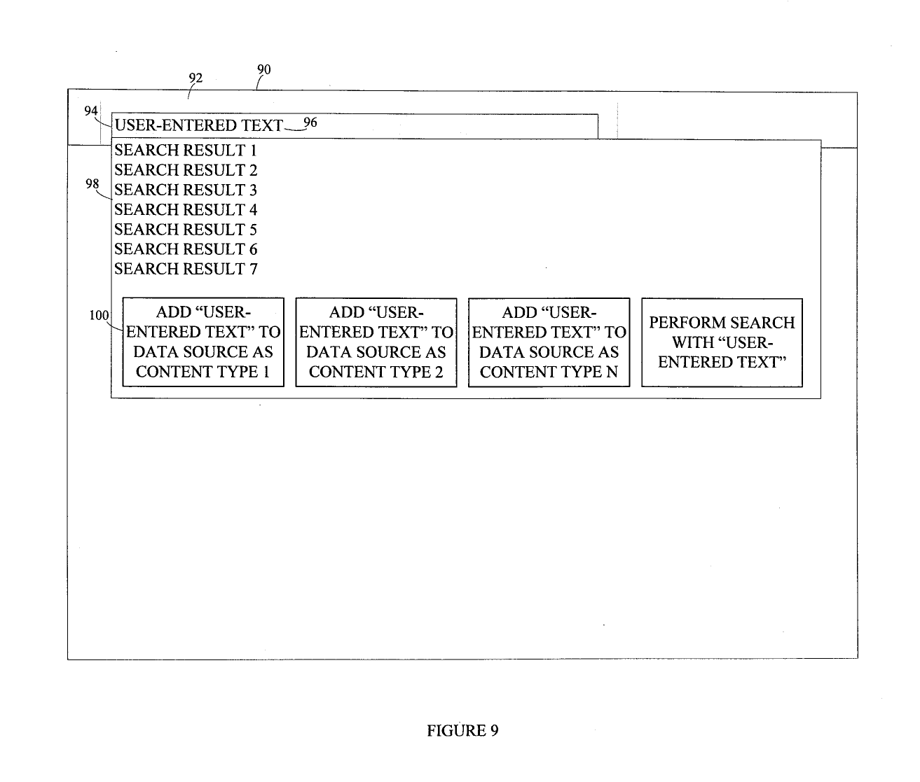

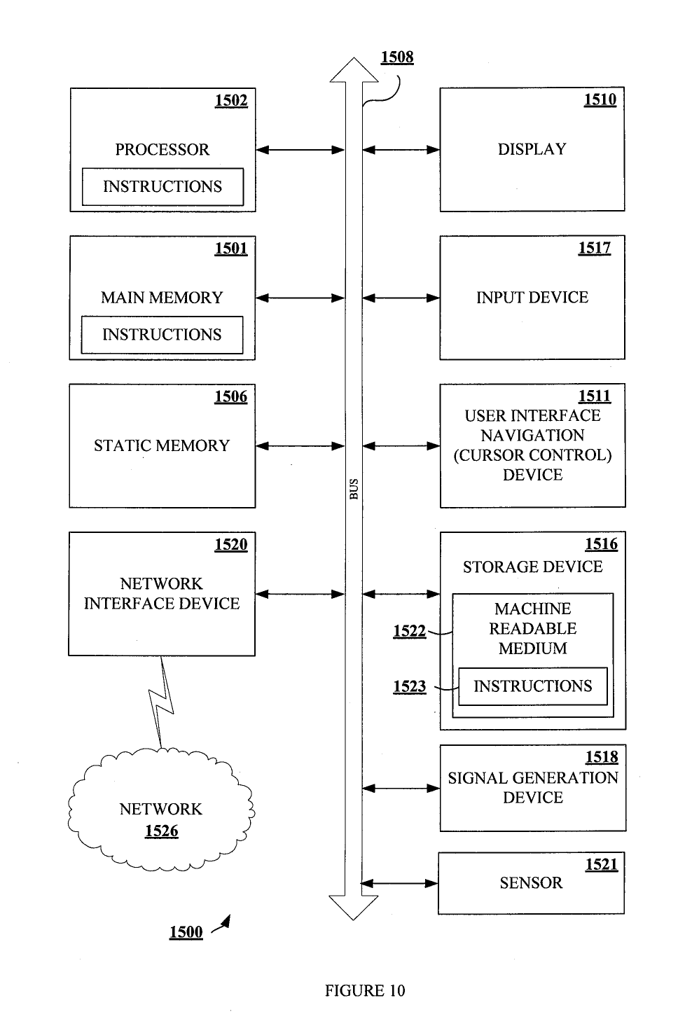

FIGS. 8 and 9 illustrate an example of a user interface for a web-based service having a multi-functional navigation bar, consistent with some embodiments of the invention. As illustrated in FIG. 8, the example user interface includes a header portion 90 that contains a multi-functional navigation bar 92 with a text input box 94. As a user enters text (e.g., “USER-ENTERED TEXT” 96) into the text input box 94, the text is automatically asynchronously communicated to a server for processing. With some embodiments, the server will analyze the text to determine one or more content types for the text. Based on the determined content type or types, the server will select one or more data sources against which a query, based on the user-entered text, is to be executed. After executing the query against the one or more data sources, the server communicates a set of search results back to the client device.

For instance, referring now to FIG. 9, the search results obtained by the server are presented at the client device in a drop down list 98 that is part of the multi-functional navigation bar 92. In various other embodiments, the search results may be displayed in a different manner or format. In addition to presenting the search results, the navigation bar displays one or more user interface elements (e.g., buttons or links) that are customized to perform a particular operation based on the analysis of the text that was entered into the text input box. For example, as illustrated in FIG. 9, the button with reference number 100, if selected by a user, causes the user-entered text to be posted to a particular data source as a particular content type (e.g., content type 1), where the content type is determined based on analyzing the user-entered text. As such, the server analyzes the text and presents one or more user interface elements that are customized, such that if selected, the text entered in the text input box is communicated to the server and processed in accordance with a particular content type associated with the selected user interface element. For example, the user interface element with reference number 102, if selected, causes the text to be communicated to the server and processed as a search term against one or more data sources.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules or logical components referred to herein may, in some example embodiments, comprise processor-implemented modules or logic.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

FIG. 7 is a block diagram of a machine in the form of a computer within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environments, or as a peer machine in peer-to-peer (or distributed) network environments. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device (e.g., drive unit 1516), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method comprising:
presenting as part of a user interface of a web-based service a text input box to receive user-entered text;
as text entered in the text input box is received from a client device, processing the received text to i) identify a type of content to which the text relates, ii) select a data source associated with the identified type of content to be searched with a query based on the received text, iii) query the data source with the query based on the received text to obtain search results from the data source, and iv) communicate the search results to the client device for presentation in a list of search results; and
presenting as part of the user interface of the web-based service a first user interface element, which, when selected, causes the text entered in the text input box to be added to the selected data source.

2. The computer-implemented method of claim 1, wherein the first user interface element is presented as part of the user interface of the web-based service only after determining the received text is a particular type of content.

3. The computer-implemented method of claim 1, wherein the received text is received in real time as it is entered into the text input box, and the search results are communicated to the client device in real time for display in the list of search results, such that the list of search results is dynamically updated with new search results that reflect changes in the text entered in the text input box.

4. The computer-implemented method of claim 1, further comprising:
presenting as part of the user interface of the web-based service a second user interface element, which, when selected, causes the text entered in the text input box to be communicated to a server for use in a query to be executed against one or more data sources; and
as a result of a selection of the second user interface element, i) receiving the text entered in the text input box, ii) querying the one or more data sources with the query to obtain search results from the one or more data sources, and iii) communicating the search results to the client device for presentation in a list of search results.

5. The computer-implemented method of claim 1, wherein each individual search result in the list of search results presented at the client device is user selectable, such that, when selected, additional information associated with the search result is communicated to the client device for display.

6. A web-based service hosted on one or more servers, at least one of the servers having a processor and memory storing instructions, which, when executed by the processor, cause the server to:
present as part of a user interface of the web-based service a text input box to receive user-entered text;
as text entered in the text input box is received from a client device, process the received text to i) identify a type of content to which the text relates, ii) select a data source associated with the identified type of content to be searched with a query based on the received text, iii) query the data source with the query based on the received text to obtain search results from the data source, and iv) communicate the search results to the client device for presentation in a list of search results; and
present as part of the user interface of the web-based service a first user interface element, which, when selected, causes the text entered in the text input box to be added to the selected data source.

7. The web-based service of claim 6, wherein the first user interface element is presented as part of the user interface of the web-based service only after determining the received text is a particular type of content.

8. The web-based service of claim 6, wherein the received text is received in real time as it is entered into the text input box, and the search results are communicated to the client device in real time for display in the list of search results, such that the list of search results is dynamically updated with new search results that reflect changes in the text entered in the text input box.

9. The web-based service of claim 6, wherein the memory stores further instructions, which, when executed by the processor, cause the server to:
present as part of the user interface of the web-based service a second user interface element, which, when selected, causes the text entered in the text input box to be communicated to a server for use in a query to be executed against one or more data sources; and
as a result of a selection of the second user interface element, i) receive the text entered in the text input box, ii) query the one or more data sources with the query to obtain search results from the one or more data sources, and iii) communicate the search results to the client device for presentation in a list of search results.

10. The web-based service of claim 6, wherein each individual search result in the list of search results presented at the client device is user selectable, such that, when selected, additional information about the search result is communicated to the client device for display.

11. A computer-implemented method comprising:
presenting as part of a user interface of a question-and-answer service a text input box to receive user-entered text; and
as text entered in the text input box is received from a client device, processing the received text to i) identify questions that have been posted to the question-and-answer service and that have text satisfying a query based on the received text, and ii) communicate the text of the identified questions to the client device for presentation in a list of search results.

12. The computer-implemented method of claim 11, wherein the received text is received in real time as it is entered into the text input box, and the text of the identified questions are communicated to the client device in real time for display in the list of search results, such that the list of search results is dynamically updated with new search results that reflect changes in the text entered in the text input box.

13. The computer-implemented method of claim 11, further comprising:
presenting with the text input box a first user-selectable user interface element that, when selected, causes text entered into the text input box to be communicated to a server of the question-and-answer service for posting as a question.

14. The computer-implemented method of claim 13, wherein the first user-selectable user interface element is presented in response to analyzing the received text to determine the received text is a question.

15. The computer-implemented method of claim 11, further comprising:
as a result of detecting a key press at the client device, receiving text entered into the text input box; and
processing the received text as a question posted to the question-and-answer service by storing the text in a database of questions.

16. The computer-implemented method of claim 11, further comprising:
as a result of detecting a key press at the client device, presenting a user interface element that prompts a user to confirm that the text entered into the text input box is to be posted to the question-and-answer service as a new question.

17. The computer-implemented method of claim 11, wherein the questions presented in the list of search results are user-selectable, the method further comprising:
as a result of a selection of a question presented in the list of search results, i) receiving a message identifying the selected question, and ii) communicating a question page to the client device for display at the client device, the question page including the text of the selected question and answers to the question, if any, that have been posted by users of the question-and-answer service.

18. A question-and-answer service hosted on one or more servers, at least one of the servers having a processor and memory storing instructions, which, when executed by the processor, cause the server to:
present as part of a user interface of the question-and-answer service a text input box to receive user-entered text; and
as text entered in the text input box is received from a client device, process the received text to i) identify questions that have been posted to the question-and-answer service and that have text satisfying a query based on the received text, and ii) communicate the text of the identified questions to the client device for presentation in a list of search results.

19. The question-and-answer service of claim 18, wherein the received text is received in real time as it is entered into the text input box, and the text of the identified questions are communicated to the client device in real time for display in the list of search results, such that the list of search results is dynamically updated with new search results that reflect changes in the text entered in the text input box.

20. The question-and-answer service of claim 18, wherein the memory stores further instructions, which, when executed by the processor, cause the server to:
present with the text input box a first user-selectable user interface element that, when selected, causes text entered into the text input box to be communicated to a server of the question-and-answer service for posting as a question.

21. The question-and-answer service of claim 20, wherein the first user-selectable user interface element is presented in response to analyzing the received text to determine the received text is a question.

22. The question-and-answer service of claim 18, wherein the memory stores further instructions, which, when executed by the processor, cause the server to:
receive text entered into the text input box as a result of the client device detecting a key press; and
process the received text as a question posted to the question-and-answer service by storing the text in a database of questions.

23. The question-and-answer service of claim 18, wherein the memory stores further instructions, which, when executed by the processor, cause the server to:
present a user interface element that prompts a user to confirm that the text entered into the text input box is to be posted to the question-and-answer service as a new question, as a result of the client device detecting a key press.

24. The question-and-answer service of claim 18, wherein the memory stores further instructions, which, when executed by the processor, cause the server to:
as a result of a selection of a user-selectable question presented in the list of search results, i) receive a message identifying the selected question, and ii) communicate a question page to the client device for display at the client device, the question page including the text of the selected question and answers to the question, if any, that have been posted by users of the question-and-answer service.

25. A computer-implemented method comprising:
presenting as part of a user interface of a question-and-answer service a text input box to receive user-entered text, and a first user-selectable user interface element that, when selected, causes text entered into the text input box to be communicated to a server of the question-and-answer service for posting as a question; and
as text entered in the text input box is received from a client device, processing the received text to identify questions that have been posted to the question-and-answer service and that have text satisfying a query based on the received text, and to communicate the text of the identified questions to the client device for presentation in a list of search results.

26. The computer-implemented method of claim 25, wherein the received text is received in real time as it is entered into the text input box, and the text of the identified questions are communicated to the client device in real time for display in the list of search results, such that the list of search results is dynamically updated with new search results that reflect changes in the text entered in the text input box.

27. The computer-implemented method of claim 25, wherein processing the received text to identify questions that have been posted to the question-and-answer service and that have text satisfying a query based on the received text includes generating a query based on the received text and executing the query against a database storing the text of questions posted to the question-and-answer service.

28. The computer-implemented method of claim 25, further comprising:
processing the received text to identify one or more topics to which questions posted to the question-and-answer service are assigned by generating a query based on the received text and executing the query against a database storing the textual names of the topics; and
communicating textual names of one or more identified topics to the client device for display in the list of search results.

29. The computer-implemented method of claim 25, further comprising:
processing the received text to identify names of one or more users of the question-and-answer service by generating a query based on the received text and executing the query against a database storing the names of the one or more users; and
communicating names of the one or more users to the client device for display in the list of search results.

30. The computer-implemented method of claim 25, wherein the questions presented in the list of search results are user-selectable, the method further comprising:
as a result of a selection of a question presented in the list of search results, receiving a message identifying the selected question, and communicating a question page to the client device for display at the client device, the question page including the text of the selected question and answers to the question, if any, that have been posted by users of the question-and-answer service.

31. The computer-implemented method of claim 25, further comprising:
as a result of a selection of the first user-selectable user interface element, receiving text entered into the text input box; and
processing the received text as a question posted to the question-and-answer service by storing the text in a database of questions.

32. The computer-implemented method of claim 25, further comprising:
presenting with the text input box a second user-selectable user interface element that, when selected, causes text entered into the text input box to be communicated to a server of the question-and-answer service for use in searching for content; and
as a result of a selection of the second user-selectable user interface element, receiving text entered into the text input box; and
processing the received text by executing a query based on the received text against one or more data sources, and communicating search results to the client device for display, the search results including one or more of: a question, a topic to which one or more questions are assigned, and a user of the question-and-answer service.

33. A question-and-answer service hosted on one or more servers, at least one of the servers having a processor and memory storing instructions, which, when executed by the processor, cause the server to perform a method comprising:
presenting as part of a user interface of the question-and-answer service a text input box to receive user-entered text, and a first user-selectable user interface element that, when selected, causes text entered into the text input box to be communicated to a server of the question-and-answer service for posting as a question; and
as text entered in the text input box is received from a client device, processing the received text to identify questions that have been posted to the question-and-answer service and that have text satisfying a query based on the received text, and to communicate the text of the identified questions to the client device for presentation in a list of search results.

34. The service of claim 33, wherein the received text is received in real time as it is entered into the text input box, and the text of the identified questions are communicated to the client device in real time for display in the list of search results, such that the list of search results is dynamically updated with new search results that reflect changes in the text entered in the text input box.

35. The service of claim 33, wherein processing the received text to identify questions that have been posted to the question-and-answer service and that have text satisfying a query based on the received text includes generating a query based on the received text and executing the query against a database storing the text of questions posted to the question-and-answer service.

36. The service of claim 33, wherein the memory stores further instructions, which, when executed by the processor, cause the server to:
process the received text to identify one or more topics to which questions posted to the question-and-answer service are assigned by generating a query based on the received text and executing the query against a database storing the textual names of the topics; and
communicate textual names of one or more identified topics to the client device for display in the list of search results.

37. The service of claim 33, wherein the memory stores further instructions, which, when executed by the processor, cause the server to:
process the received text to identify names of one or more users of the question-and-answer service by generating a query based on the received text and executing the query against a database storing the names of the one or more users; and
communicate names of the one or more users to the client device for display in the list of search results.

38. The service of claim 33, wherein the memory stores further instructions, which, when executed by the processor, cause the server to:
as a result of a selection of a user-selectable question presented in the list of search results, receive a message identifying the selected question, and communicate a question page to the client device for display at the client device, the question page including the text of the selected question and answers to the question, if any, that have been posted by users of the question-and-answer service.

39. The service of claim 33, wherein the memory stores further instructions, which, when executed by the processor, cause the server to:
as a result of a selection of the first user-selectable user interface element, receive text entered into the text input box; and
process the received text as a question posted to the question-and-answer service by storing the text in a database of questions.

40. The service of claim 33, wherein the memory stores further instructions, which, when executed by the processor, cause the server to:
present with the text input box a second user-selectable user interface element that, when selected, causes text entered into the text input box to be communicated to a server of the question-and-answer service for use in searching for content; and
as a result of a selection of the second user-selectable user interface element, receive text entered into the text input box; and
process the received text by executing a query based on the received text against one or more data sources, and communicating search results to the client device for display, the search results including one or more of: a question, a topic to which one or more questions are assigned, and a user of the question-and-answer service.
